(19) United States
(12) Patent Application Publication
(10) Pub. No.: US 2008/0281863 A1
(43) Pub. Date: Nov. 13, 2008

(54) Repository system and method

(75) Inventors: Radek Pospisil, Neratovice (CZ); Martin Dvorak, Prague (CZ); Tomas Vocetka, Prague (CZ)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-packard development company, L.P.

(21) Appl. No.: 11/798,117

(22) Filed: May 10, 2007

(51) Int. Cl. G06F 12/00

(52) U.S. Cl. 707/103 R

(57) ABSTRACT

A method and apparatus are described relating to a repository having artifacts stored therein. A client 10 may request an object for a first time from a repository 20 with message 60 and receives a first response 62 from the repository including a representation of the object and a pointer to at least one relation of the object. The client 10 may then request a related artifact with further message 64 and receive a further response 66 including a copy of the requested related artifact. The related artifact returned may be the instance of the related artifact valid at the first time. In this way, the repository at a particular time may be accessed by client 10. The repository may be a stateless repository which does not hold data on the client state.

### FIELD OF THE INVENTION

The invention relates to a method, apparatus, and computer program product that acts as a repository, particularly but not exclusively a stateless repository.

### BACKGROUND OF THE INVENTION

There has been considerable interest in recent times in the provision of web services, i.e. the provision of services on the internet that do not simply provide web pages for display to human users.

One approach that has been adopted to deal with this situation is a registry or repository for defining aspects of web-available services. For example, the universal description discovery and integration (UDDI) standard defines an extended markup language (XML) based registry that allows services to be published with details about the service provided. Such registries can be interrogated for further information which may, for example, include web service description language (WSDL) documents defining web services, including protocol bindings and message formats. The registry will normally be interrogated by messages in a standard format, such as the SOAP format (formerly an abbreviation of Simple Object Access Protocol), or other suitable formats.

There are a number of models for exchanging data from a server with the data to a client to which the data is provided. In a traditional client-server approach, all of the information about the data format is hidden from the client, that is to say encapsulated.

A development of this approach is known as the Representational State Transfer (REST) approach, in which an artifact is transferred from a server to a client using one of a number of standard data types. The data type used for the transfer may be selected dynamically, for example based on the capability or desire of the client and the nature of the artifact. The representation may include instructions in a standard format, for example Java instructions where the client is known to support Java.

The interface does not reveal whether the data type used for the transfer is the format stored by the server to store the data, or merely a derivation of that format, so in this sense there is encapsulation.

The REST approach is a stateless approach, that is to say the server does not store the state of the session with the client. The session state is therefore kept only on the client.

### BRIEF DESCRIPTION OF THE DRAWINGS

Embodiments will now be described, purely by way of example, with reference to the accompanying drawings, in which:

FIG. 1 shows a schematic of apparatus including a repository;

FIG. 2 illustrates updating artifacts in the repository; and

FIG. 3 illustrates messages passed between a client and the repository in the arrangement of FIG. 1;

FIG. 4 illustrates the implementation of the apparatus of FIG. 1;

FIG. 5 illustrates a pair of artifacts stored in the repository of FIG. 1;

FIG. 6 illustrates a tree structure of artifacts; and

FIG. 7 illustrates an example of relations between artifacts.

The drawings are purely schematic and not to scale.

### DETAILED DESCRIPTION

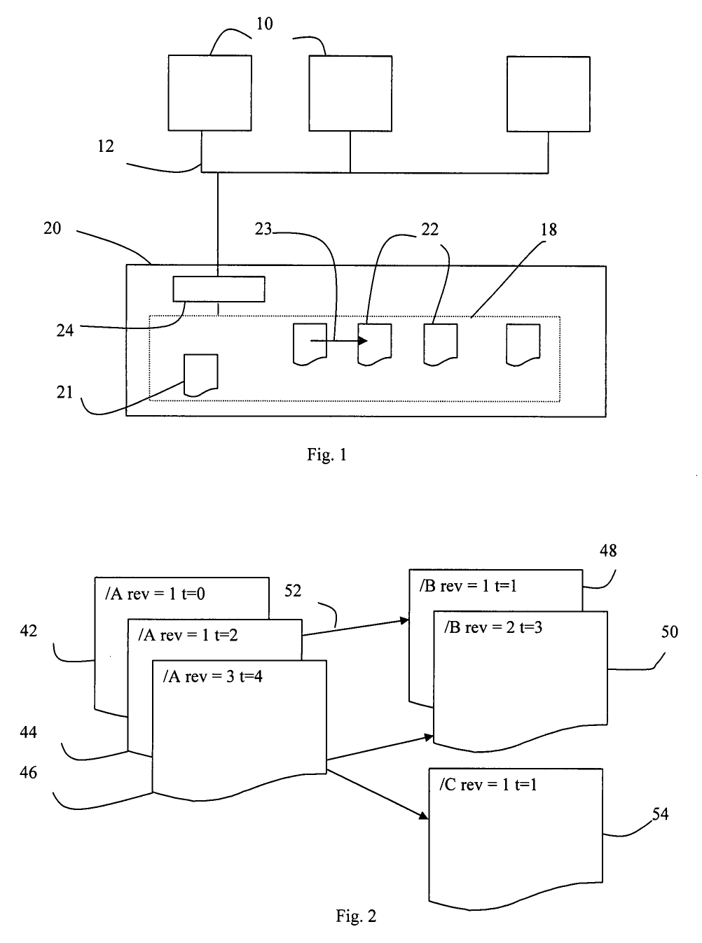

Referring to FIG. 1, one or more clients 10 are connected to a server 20 including a database 18.

The unit of stored data is an artifact 22, which may be thought of as a general object, or resource, in general containing data, code, or some defined mixture. The artifact 22 is the access unit for the contents of the database, and each request received from a client 10 returns only one artifact 22.

The definitions of the artifacts are stored in a special file in the repository, namely a SDM 21, a system device model, or model description, which is in the form of a document which stores format details of a number of different types of artifacts. In the embodiment, the SDM is an XML document defining a number of artifacts and attributes of the artifacts which will be referred to as properties. The abstract definition of a property of an artifact will be referred to as a property descriptor.

Each artifact is defined in the SDM 21 to have one or more properties, which may be defined to be either required or optional. Required properties, for example, may include a name of the artifact and a unique numeric ID.

Optional properties may include, for example, a geographic location property defining the geographic location that created a particular instance of the artifact may be defined as optional.

The database 18 stores in addition to the SDM model 21 instances of artifacts 22 compliant with the definitions in the SDM model 21. Relations 23 between instances of the artifacts are indicated schematically using arrows. The relations 23 are from a source artifact to a target artifact, and are considered to be properties of both the source artifact and the target artifact.

FIG. 2 illustrates a pair of artifacts, artifact/A 42,44,46 and artifact/B 48,50 over time, together with a third artifact/C 54.

In the initial state (time t=0) a first instance 42 of artifact/A exists in revision 1 and artifact/B has not yet been created.

Next, at time t=1, artifact/B is created and a record 48 of artifact/B with time t=1 and revision=1 is created and stored.

Then, at time t=2, artifact/A is amended to add an outgoing relation to artifact B. A second instance 44 of artifact/A is created with revision=2, time t=2 and with the outgoing relation to/B, indicated schematically by arrow 52. The relation is to artifact/B at time t=1, since that is the current instance of artifact/B at time t=2. The first instance 42 of artifact/A is not deleted, but retained in the repository 20.

Next, at time t=3, artifact/B is amended, for example to change the data carried by artifact/B. A second instance 50 of artifact/B is created, and as with artifact/A the first instance 48 is not deleted. Note that the pointer from the second instance 44 of artifact/A still points to the first instance 48 of artifact/B, not the second instance 50 of artifact/B. This gives the tree structure useful properties as will be explained below.

Then, at time t=4 artifact/A is amended again, for example by adding a further relation to a further instance 54 of different artifact/C. A third instance 46 of artifact/A is therefore created, again without deleting either of the two previous instances 42,44, with revision=3 and time t=4. Note that the third instance 46 of artifact/A points to the second instance 50 of artifact/B since that is the current instance of artifact/B at time t=4 even though the outgoing relation to artifact/B has not changed.

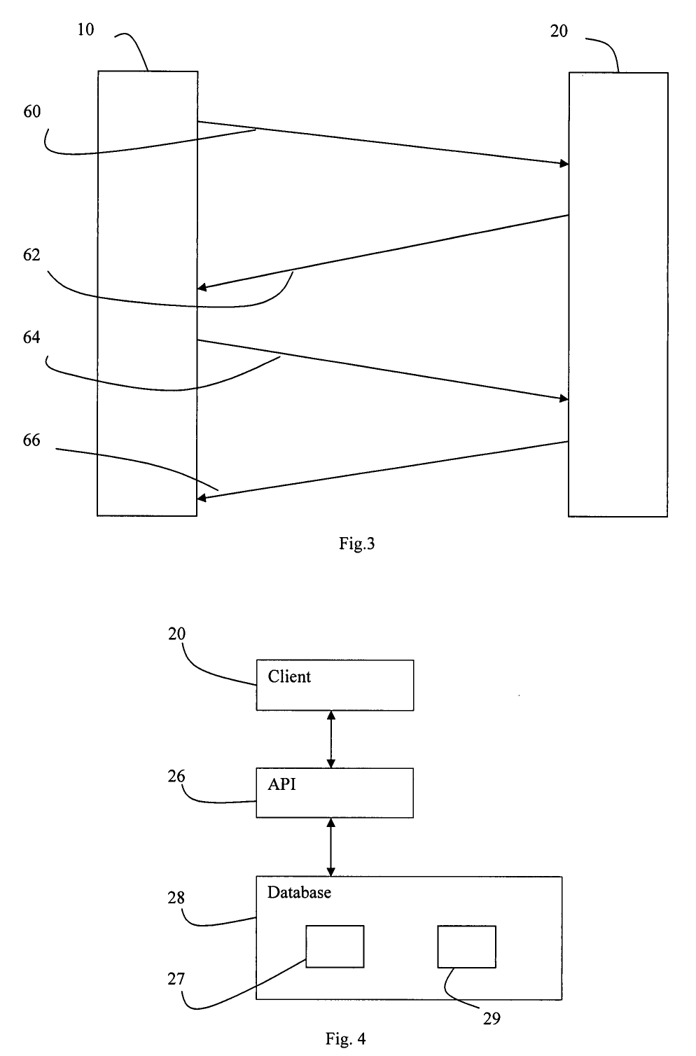

Consider now accessing the artifacts from a client 10, illustrated in FIG. 3 which shows messages 60, 64 from client 10 to repository 20 and artifacts 62, 66 returned in response. In the embodiment, these messages are GET and POST http messages, but any suitable protocol may be used.

Suppose that the client 10 starts a process at time t=2.5, and sends a message 60 to repository 20 requesting artifact/A. The repository 20 returns a copy 62 of artifact/A at that time, including outgoing relations which are at current time t=2.5.

Next, suppose that the client 10 continues processing and some time later at time t=4.5 the process requires artifact/B which is pointed to by the copy 62 of artifact/A sent to the client 10. The client 10 accordingly sends a further message 64 to the repository requesting artifact/B. This message 64 includes the pointer to/B returned in the copy 62 of artifact/A. The repository 20 receives this message and returns the copy of artifact/B valid at time t=2.5, since this is the copy pointed at by the pointer, and accordingly returns a copy 68 of the first instance 48 of artifact/B.

In this way, the process running on client 10 effectively accesses the database at the time of the initial access (t=2.5 in the example) and all subsequent accesses of the database return values of the database at the same time. This is achieved without locking any records or saving any transaction information about the client 10 on the repository 20.

Moreover, after the first data is accessed, the client simply follows the pointers provided by the repository 20; it does not need to carry out any special processing whatsoever to ensure that all of the data it accesses is for a specific time. The pointers passed by the repository 20 include implicitly the time information. This means that conventional and existing programs that follow relations in a tree-structure using pointers can be used without change—all necessary time information is contained in the pointers returned by the repository as part of the artifacts accessed.

In the example, the copy 62 of the artifact sent to the client 10 includes outgoing relation pointers that point to the specific instances of the other artifacts at the appropriate time, here t=2.5. Thus, in the above example, the copy 62 of artifact/B sent to the client includes a specific pointer pointing to the first instance 48 of artifact/A and not the second since at the appropriate time t=2.5 the first instance 48 is the valid artifact. The client process returns this pointer in the further message 64 requesting artifact/B and the server returns the correct instance of the artifact/B based on this pointer.

Thus, the embodiment effectively delivers consistent data from a repository even if the repository is updated while the client process 10 is running. No lock on the data or transaction information in the server is required. This applies even if the client process 10 is a long one, and even if the client process itself has no programming to ensure that

It will be appreciated that at some later time (t=5) the client 10 may start a new process. The new process may access the data at the later time.

A particular example will now be described in more detail. In the particular example, the SDM model is an XML file which contains a number of the following entities, as appropriate.

Firstly, the SDM model includes taxonomy descriptors, which describe taxonomies used for categorizing property descriptors (see below).

Secondly, the SDM model includes predetermined property types, i.e. base types such as string, integer, and other types that may be used for properties.

Thirdly, the SDM model includes property descriptors, i.e. descriptors specifying for each property the type of values stored by the property, whether a taxonomy or a property type, as well as further information such as XML serialisation and value range if required.

Fourthly, the SDM model includes artifact descriptors, declaring XML serialisation and a list of properties for artifacts. Some artifacts can be abstract, i.e. instances of the artefact are used as base classes for other artefacts.

Fifthly, the SDM model can include artefact taxonomy, ordering the artifact, which normally does not follow the inheritance of artifacts.

The server 20 is configured, in this example, as a REST repository which stores a plurality of artifacts 22. The repository is accessed through a web service interface 24 which in the example is a an API interface, for example it may be a UDDI interface. However, the repository need not necessarily be a REST repository and the server need not necessarily use a UDDI interface. In the example, the repository is accessed by http GET and POST instructions.

FIG. 4 illustrates schematically the way repository 20 of this example is implemented. Underlying the repository is a database 28 which stores the data of the repository, for example in tables 27. Thus, the data is not stored, in the example, in the same XML format used to deliver data from the repository. The use of relation table 29 in the database is described below.

An application programming interface (API) 26 acts as an interface between the repository 20 and the database 28.

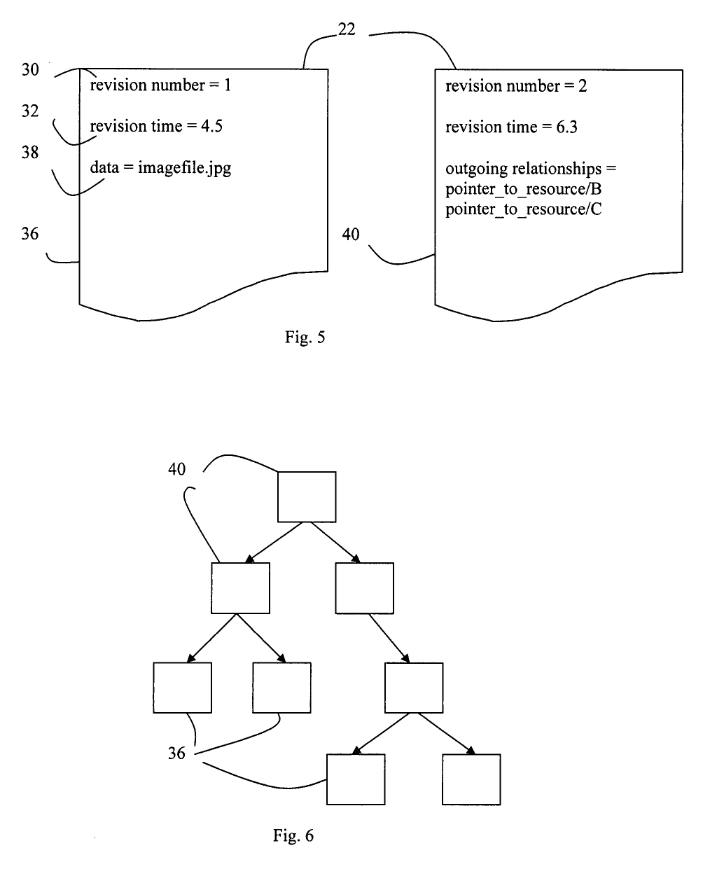

FIG. 5 illustrates two instances of artifacts 22 in more detail. The artifacts each include a revision number 30, revision time 32, and optionally one or more outgoing relations 34, which are pointers to other artifacts. The artifact may optionally be a data artifact 36 carrying data 38. Alternatively, the artifact can be a collection artifact 40 carrying no data. The collection artifact is essentially a directory.

In an example, the inheritance of the artifacts are arranged in a tree structure as illustrated in FIG. 6 in which the leaves of the tree are data artifacts 36 and non-leaf artifacts are collection artifacts 40. In other words, in the specific embodiment the collection artifacts 40 carry no data—this constraint may be relaxed in alternative embodiments.

It should be noted that the repository is not a simple WSDL repository that stores only documents in a single precisely defined WSDL format. Instead, the repository is a repository for storing a much broader range of data.

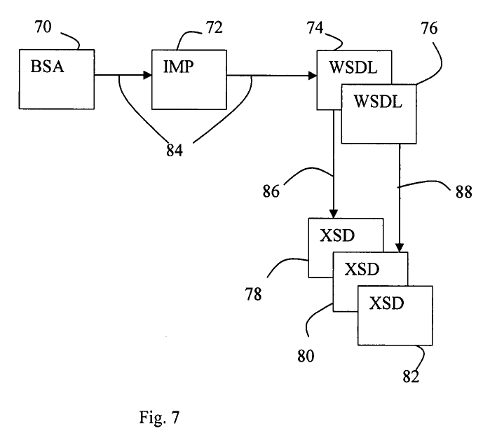

In an example, consider an instance of a business service artifact 70 as illustrated in FIG. 7. The artifact uses, and hence has a relation to, an instance of an implementation artifact 72, which in the example includes details of the implementation of artifact 70 on a particular kind of database, say an Oracle database. There may be alternative implementation artifacts 72 on the system, including implementation details of a business service artifact on a different database, for example a SQL database. By having a relation to the Oracle implementation artifact, the implementation of artifact 70 is set to be Oracle.

Further, the implementation artifact 72 may have a relation 84 to a WSDL document 74, 76. Note that the WSDL document 74 has two versions, an initial WSDL artifact 74 and a revised WSDL artifact 76. The relation 84 is a relation of the type that simply takes the latest version, so the relation is automatically updated from a relation between the implementation artifact 72 and initial WSDL artifact 74 to a relation between the implementation artifact 72 and revised WSDL artifact 76 when the revised WSDL artifact 76 is included in the database.

The WSDL artifact 74,76 in turn has a relation 86,88 to an XML schema definition (XSD) 78, 80, 82. This also has a number of updates, from an initial version 78 to a revised version 80 and then subsequently to a further revised version 82. Unlike relation 84, this relation 86,88 is of a different type and is to a specific time instance of the XSD artifact. Thus, initial WSDL artifact 74 has a relation with the current version of the XSD artifact 78, 80, 82 at the time the WSDL artifact 74 was created. At a later time, when the revised WSDL artifact 76 is created, the current version of the XSD artifact is the revised version 80 and accordingly the relation between revised WSDL artifact 76 is with revised XSD artifact 80. A later revision of the XSD artifact 80 to provide further revised XSD artifact 82 does not alter the relation between revised WSDL artifact 76 and revised XSD artifact 80.

By ensuring that the WSDL artifacts 74,76 use a specific version of the XSD artifacts any validation of the WSDL artifact, which requires testing for compatibility with the XSD artifact, is not rendered invalid by amendment of the XSD artifact.

The user of the repository can select when creating relations between artifacts 22 whether to create relations to the latest version of some other artifact, such as relation 84, or to specific versions of some other artifact, such as relations 86, 88.

It will be appreciated that in general the pattern of relations between artifacts can be quite complex, much more so than in the example.

The properties of the artifact are represented in XML. As an example, consider a business service artifact, defined as follows:

```
<?XML version=“1.0” encoding=“UTF-8”?>
<a:businessServiceArtifact deleted=“0”
xlink:href=“businessServiceArtifacts/2.XML”
  <g:nameGroup>
    <p:name XML:lang=“en”>My First Servce</p:name>
  </g:nameGroup>
  <g:descriptionGroup>
    <p:description XML:lang=“en”>description</p:description>
  </g:descriptionGroup>
    <p:criticality name=“Low”
taxonomyUri=“uddi:systinet.com:soa:model:taxonomies:impactLevel”
value=“uddi:systinet.com:soa:model:taxonomies:impactLevel:low”/>
    <p:categoryBag
    <pt:category name=“Agriculture, Forestry, and Fishing”
taxonomyUri=“uddi:70a80f61-77bc-4821-a5e2-2a406acc35dd”
value=“0”/>
    <pt:category name=“Change management”
taxonomyUri=“uddi:systinet.com:soa:model:taxonomies:reportCategories”
value=“uddi:systinet.com:soa:model:taxonomies:reportCategories:change
Management”/>
  </p:categoryBag>
  <p:importedIMPDocument deleted=“0”
xlink:href=“XMLSchemas/Book2.imp?revision=0” />
  <p:revision>2</p:revision>
  </a:businessServiceArtifact>
```

The artifact is defined to have a number of properties which are specified by XML statements in the form <p:name_of_property data/> or <p:name_of_property> data </p:name_of_property>, where the property name is name_of_property. Thus, in the example, the “revision” property has the (numeric) data “2”. This indicates the second revision of the artifact.

A further example is the property “criticality name”, which in the example takes the value “Low”. This value is taken from a taxonomy defined at a uri uddi:systinet.com:soa:model:taxonomies:impactLevel and having a value defined at the uri uddi:systinet.com:soa:model:taxonomies:impactLevel:low. Thus, it will be seen in this example that the property is effectively typed, that is to say it can have only predetermined values defined in the taxonomy definition file explicitly referenced in the instance of the artifact.

The example also has a “categoryBag” property that may be used to store a number of different types of taxonomy information, i.e. untyped or free-format data. In he example, the artifact has a defined category value of “Agriculture Forestry and Fishing”, from the taxonomy defined at uddi:70a80f61-77bc-4821-a5e2-2a406acc35dd″, which defines a particular business service area, and a further category value of “change management” from the taxonomy defined at uddi:systinet.com. In particular, the artifact may have properties defined to store data.

Thus, when creating an instance of the business services artifact, any property from any taxonomy may be used to classify the instance, even if this was not foreseen when designing the artifact.

As well as properties, instances of the artifacts contain relations, i.e. references to other artifacts. In terms of the data supplied in response to data requests, the artifacts have conceptually both outgoing and incoming relations. In the example above, there is a single relation, an outgoing relation to an artifact “XMLSchemas/Book2.imp?revision=0”.

Data may be stored in the artifact using a suitable property, which may contain, for example, a portable document format (pdf) document, or a pointer to an html data file. The data may include, for example, program code, for example JAVA code, and/or static documents.

The above example illustrates the XML representation of the artifact. However, since the repository in the example is a REST repository, this is not necessarily the form in which the artifact is stored.

A client program 10 is used to define and amend the artifact definitions. In the specific example, one client program is used to amend the SDM 21, and store updates of the SDM 21 in database 18.

A number of instances of the artifact(s) defined in the SDM are then created and stored in the database 18. As will be appreciated, there may be one, many or indeed no instances of any particular defined artifact stored in the database.

One important fact to note in the implementation is that the implementation is a REST type repository, and there is some encapsulation of the data in the sense that the data supplied by the REST repository in one format need not necessarily be stored in the repository in that format. In particular, in the embodiment, the relations are stored in a separate table in the database storing all relations, and this table is separate from the remainder of the features of each artifact.

In view of the possible complexity of the model, there may well be a need to check for the internal consistency of the model. As will be appreciated, it would in principle be possible to make multiple changes that are incompatible. For example, it may be possible to amend the definitions of the artifacts in a way that is incompatible with data already stored in the database. The client program 10 for entering changes in the SDM accordingly can run such a check.

For a large model and large database storing significant amounts of data, the time to run a complete check can be large, of order several hours. The difficulty with this is that the data in the database might change while this is being done. In some conventional databases, the data can be locked in some way, or marked for editing. However, a property of the REST type database used in the example is that it is stateless. Therefore, data about the client state is not stored on the database. Nor does the REST model that is used allow for locking of the database.

Even if the database structure were modified to allow locking of the underlying database in some way, this is inconvenient.

For this reason, the way which data is stored and delivered in the example makes it possible to access the data at a particular time. In the example, this is achieved by storing the relations of all artifacts with each in a separate table in the database 28 to the tables storing the other information, which will be referred to as the relation table 29 (FIG. 4).

In this way, a long check such as that mentioned above can be carried out on the state of the database at a particular time. Changes to the database after the check is started will not be included in the check so any inconsistencies caused by changes in the data over time will not interfere with the check or cause an unnecessary failure result.

The data structure underlying the above functionality in the embodiment will now be described. The relation table 29 defines for each relation between an instance of a source artifact and an instance of a target artifact a creation time, i.e. the time that the relation was created, a source of the relation, that points to the source artifact, and a target of the relation, pointing to the target artifact. The target can be specified to be either a particular time instance of the target artifact, i.e. a particular revision, or can also be specified to simply point to the artifact, in which case the latest time instance of the target artifact will be taken.

If the relation is subsequently deleted, the relation table will be updated by a deletion time, a source artifact, pointing to the correct instance of the source at the time of deletion, and a target artifact, pointing to the correct instance of the target at the time of deletion.

Thus, the relation is valid from the creation time to the delete time. The way the relation is stored provides the server with the information needed to report the relation at particular times as discussed above.

The data access in the embodiment is controlled by messages, in the particular embodiment these are http GET messages sent by clients 10 to repository 20 and responses. Returning to the example of FIG. 7, consider a client 10 getting data about the second time instance of WSDL document 76, i.e. the instance valid at a specific time, for example the current time. This is done by a GET operation:

### GET

http://localhost:8080/soa/systinet/platform/rest/repository/wsdls/Book Library4.wsdl?desc&datetime=2007-04-23T14:49:55.0Z
which requests a particular time instance of the wsdl document, i.e. an instance of the wsdl artifact at a particular date and time (in the example 23 Apr. 2007 at 14.49.55).

The response is an XML file including definitions of the relations, which is sent by the repository 20 back to client 10. The XML file is truncated: it also includes properties and property values that have been omitted for clarity.

```
<?XML version=“1.0” encoding=“UTF-8”?>
<rest:resource
xlink:href=“http://localhost:8080/soa/systinet/platform/rest/repository/
wsdls/BookLibrary4.wsdl”>
<a:wsdlArtifact deleted=“0” xlink:href=“wsdls/BookLibrary4.wsdl”
    <g:importedXsdDocumentGroup>
<p:importedXsdDocument deleted=“0”
xlink:href=“XMLSchemas/Book2.xsd?revision=0&amp;
datetime=2007-04-23T14:49:55.000Z”/>
  </g:importedXsdDocumentGroup>
<g:definitionOfGroup>
    <definitionOf deleted=“false”
xlink:href=“serviceArtifacts/5?datetime=2007-04-23T14:49:55.000Z”
XMLns=“http://systinet.com/2005/05/soa/model/property”
XMLns:xlink=“http://www.w3.org/1999/xlink”/>
  </g:definitionOfGroup>
<p:lastRevision>1</p:lastRevision>
<p:revision>1</p:revision>
</a:wsdlArtifact>
</rest:resource>
```

This returned a single item in the group <g:importedXsdDocumentGroup> which includes a single property <p: importedXsdDocument deleted=“0” xlink:href=“XMLSchemas/Book2.xsd?revision=0&amp;datetime=2007-04-23T14:49:55.000Z”/>. This is an outgoing relation pointing to a particular time instance of xsd file 80. In the event that there were more xsd documents referenced, hence more outgoing relations, there would be more properties defined in the group.

The response also includes a single item in the group <g:definitionOfGroup> namely the item <definitionOf deleted=“false”

xlink:href=“serviceArtifacts/5?datetime=2007-04-23T14:49:55.000Z”
XMLns=“http://systinet.com/2005/05/soa/model/property”
XMLns:xlink=“http://www.w3.org/1999/xlink”/>.

This item is an incoming relation from a service artifact stored at the particular url indicated. Again, in the event that the WSDL artifact was referenced from multiple other documents there would be multiple instances. Again, the reference in the XML is explicitly time dated.

If the client 10 then wishes to access the XSD artifact referenced by the WSDL artifact then the client returns the GET command to the repository 20:

### GET

http://localhost:8080/soa/systinet/platform/rest/repository/XML Schemas/Book2.xsd?revision=0&desc&datetime=2007-04-23T14:49:55.000Z

Note that this command simply calls the explicit address (url) previously returned in the last response, including the date and time information included in that address.

The response then returns the requested time instance of the XSD document, namely:

<?XML version=“1.0” encoding=“UTF-8”?>
<rest:resource
xlink:href=“http://localhost:8080/soa/systinet/platform/rest/repository/
XMLSchemas/Book2.xsd”
<a:XMLSchemaArtifact deleted=“0”
xlink:href=“XMLSchemas/Book2.xsd”
<g:xsdImportedByGroup>
<xsdImportedBy deleted=“false”
xlink:href=“wsdls/BookLibrary4.wsdl?datetime=2007-
04-23T14:49:55.000Z”
XMLns=“http://systinet.com/2005/05/soa/model/property”
XMLns:xlink=“http://www.w3.org/1999/xlink”/>
</g:xsdImportedByGroup>
<p:lastRevision>1</p:lastRevision>
<p:revision>1</p:revision>
</rest:resource>

Thus, in this case the incoming relation defined by the xsdlmportedBy entry indicates the specific time instance of the WSDL artifact that imported the xsd artifact returned. In other words, the xsdImportedBy entry defines in XML the inbound relation that was used to reach this artifact.

The same approach can be used to reference data incorporated in a similar way. Consider for example the GET operation:

### GET

http://localhost:8080/soa/systinet/platform/rest/repository/wsdls/Book Library4.wsdl?datetime=2007-04-23T14:49:55.0Z

```
RESPONSE (truncated):
<wsdl:definitions XMLns:wsdl=“http://schemas.XMLsoap.org/wsdl/”
XMLns:tns=“http://www.library.com/services/wsdl/BookService.wsdl”
XMLns:xsd=“http://www.w3.org/2001/XMLSchema”
XMLns:soap=“http://schemas.XMLsoap.org/wsdl/soap/”
XMLns:xsd1=“http://www.americanexpress.com/poc/xsd/Book.xsd”
name=“BookLibrary”
targetNamespace=“http://www.library.com/services/wsdl/
BookService.wsdl”>
    <wsdl:types>
    <xsd:schema
targetNamespace=“http://www.library.com/services/wsdl/
BookService.wsdl”>
<xsd:element name=“BookId” type=“xsd:string”/>
        </xsd:schema>
      <xsd:schema>
      <xsd:import
namespace=“http://www.americanexpress.com/poc/xsd/Book.xsd”
schemaLocation=“http://localhost:8080/soa/systinet/platform/rest/
repository/XMLSchemas/Book2.xsd?datetime=2007-04-
23T14:49:55.000Z”>
        </xsd:import>
```

In this case, the xsd file imports a schema defined in the namespace referenced at www.americanexpress.com/poc/xsd/Book.xsd and the particular schema is time referenced to a specific time instance of the schema.

Although the above description describes only a very limited number of instances of artifacts, in a real repository many more artifacts may be supplied to a client as part of a single process. This applies in particular to a validation process for checking data in a repository.

Those skilled in the art will appreciate that modifications to the described embodiment are possible.

For example, it is not necessary that the time information is returned explicitly in the copy 62 of artifact sent by repository 20 to client 10. Instead, as long as the pointer refers to the specific time instance, the pointer need not include express information about the time instance.

In alternative embodiments, the time information may be returned in the GET from client to server as an explicit separate data item rather than as part of the pointer to the artifact as in the examples above.

Alternative embodiments can use any data format for the messages understood by both client and repository, not necessarily GET and POST operations as above.

The client and repository and links between them may be implemented using standard computers and networks of computers using one or more data storage devices and one or more processors, as is known to those skilled in the art.

The updating of the artifacts in the repository may be done by one or more clients, or may be done by directly updating the artifacts in the repository.

Those skilled in the art will realise that any alternative way of storing the data, for example in database tables, may be used instead. For example, the specific way in which data is stored in the repository can match exactly the format of the messages described. Indeed, the REST framework allows data to be stored in the repository in any convenient way as long as the artifact can be formatted correctly when returned to the client.

I claim:

1. A method of operating a repository and a client in communication, comprising:
defining a plurality of artifacts in the repository;
updating one or more relations between a source artifact and a target artifact;
sending a message from a client to the repository requesting a first artifact for a first time, accessing the repository and returning to the client a representation of the first artifact including at least one relation referring to one or more target artifacts;
sending a further message from the client to the repository requesting a further artifact, based on one of the one or more relations in the representation of the first artifact, the further message including information specifying that the instance of the further artifact required is the instance at the first time; and
accessing the repository and returning the instance of the second artifact to the client.

2. A method according to claim 1 wherein the copy of the first artifact returned to the client includes an outgoing relation pointer pointing to an instance of the second artifact at the first time, and wherein the client includes the outgoing relation pointer in the further message specifying that the instance of the second artifact required is the instance at the first time.

3. A method according to claim 2 wherein the information in the further message specifying that the instance of the second artifact required is the instance at the first time is a data field indicating the first time.

4. A method according to claim 1 wherein the copy of the first artifact returned to the client includes an explicit representation of the first time, and the client returns the first time from the copy in the further message.

5. A method according to claim 1 wherein the artifacts include at least one data artifact carrying data and at least one collection including at least one of a data artifact and another collection.

6. A repository for use with one or more clients, the repository comprising:
a database storing a plurality of artifacts, wherein the database stores a plurality of relations, each relation being a relation between a source artifact and a target artifact, the source artifact and target artifact being related artifacts; and
an applications interface for receiving a query message from one of the one or more clients requesting a requested artifact for a specific time, for responding to the query message with a response message including a representation of the requested artifact, and for including in the message pointers to any artifact related to the requested artifact, each pointer being to the instance of the related artifact at the first time.

7. A repository according to claim 6, wherein the database comprises:
a model description defining possible types of artifacts and their contents;
a relationship table storing the relations between artifacts; and
at least one table storing information about the artifacts that is not stored in the relationship table.

8. A repository according to claim 7 wherein the relationship table stores for each relation:
the time the relation was created;
a pointer to an instance of the source artifact at the time the relation was created;
a pointer to an instance of the target artifact at the time the relation was created; and, if the relation has been deleted:
the time the relation was deleted;
a pointer to an instance of the source artifact at the time the relation was deleted; and
a pointer to an instance of the target artifact at the time the relation was deleted.

9. A repository according to claim 6, wherein one or more relations stored in the database include:
at least one first relation of a first type defining a relation between a source artifact and the most recent time instance of a target artifact; and
at least one second relation of a second type defining a relation between a source artifact and a specific instance of a target artifact.

10. A repository according to claim 6 wherein the repository is a stateless repository.

11. A method of operating a repository in communication with a client, comprising:
storing in the repository a plurality of artifacts and at least one relation between a source artifact and a target artifact;
responding to a request from a client for a requested artifact with a response message including an artifact, including in the message a pointer to at least one related artifact related to the requested artifact, the at least one pointer being to the instance of the related artifact at the first time.

12. A method according to claim 11, further comprising:
receiving a further message from the client, the further message including a selected pointer selected from at least one pointer included in the response message; and
replying to the further message with the instance of the related artifact indicated by the selected pointer.

13. A method according to claim 11, further comprising:
creating a new relation between a new source artifact and a new destination artifact; and
storing in the database:
the time the new relation was created;
a pointer to an instance of the source artifact at the time the relation was created; and
a pointer to an instance of the target artifact at the time the relation was created.

14. A method according to claim 11, further comprising:
deleting a relation between a source artifact and a target artifact; and
storing in the database:
the time the deleted relation was deleted;
a pointer to an instance of the source artifact at the time the relation was deleted; and
a pointer to an instance of the target artifact at the time the relation was deleted.

15. A data repository for use in communication with a client, comprising:
means for storing a plurality of artifacts and at least one relation between a source artifact and a target artifact in the repository; and
means for responding to a request from a client for a requested artifact with a with a response message including an artifact, including in the message a pointer to at least one related artifact related to the requested artifact, the at least one pointer being to the instance of the related artifact at the first time.
